(19) United States
(12) Patent Application Publication
(10) Pub. No.: US 2006/0279767 A1
(43) Pub. Date: Dec. 14, 2006

(54) Method and apparatus for detecting specific pattern and copying machine including the same

(75) Inventor: Sung-hyun Lim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/449,631

(22) Filed: Jun. 9, 2006

(30) Foreign Application Priority Data
Jun. 10, 2005 (KR) 10-2005-0049697

(51) Int. Cl. G06K 15/00; G06F 15/00

(52) U.S. Cl. 358/1.14; 382/174; 382/173; 358/1.9

(57) ABSTRACT

A specific pattern detection method and apparatus for detecting whether an input image includes a specific pattern included in a bill, which may not be copied, and a copying machine including the same are provided. The specific pattern detection method includes extracting objects corresponding to marks of a specific pattern from an input image. The extracted objects are examined as to whether they have the same location relationship as the marks of the specific pattern. The objects having the same location relationship are verified to determine whether the objects are equal to the marks of the specific pattern. The specific pattern is determined as to whether the pattern exists in the input image from a result of the verification. Accordingly, the presence of the specific pattern in the input image can be instantly detected.

### CROSS-REFERENCE TO RELATED PATENT APPLICATION

This application claims the benefit under 35 U.S.C. §119(a) of Korean Patent Application No. 10-2005-0049697, filed on Jun. 10, 2005, in the Korean Intellectual Property Office, the entire disclosure of which is hereby incorporated by reference.

### BACKGROUND OF THE INVENTION

1. Field of the Invention

The present invention relates to image processing for pattern detection. More particularly, the present invention relates to image processing for a specific pattern detection method and apparatus for detecting whether an input image includes a specific pattern included in currency which may not be copied, and a copying machine including the same.

2. Description of the Related Art

Recently, the performance of color copying machines using color scanners has improved, which increases the risk of reproduction of documents which should not be copied, such as currency or securities. To prevent the reproduction of documents which should not be copied, color copying machines often use an anti-counterfeit device for detecting documents which should not be copied and handling output images whose reproduction is prohibited.

Technology for preventing reproduction by detecting a specific pattern included in a bill is disclosed in U.S. Pat. No. 6,289,125 entitled “Image processing device and method for identifying an input image, and copier scanner and printer including same,” the entire contents of which are hereby incorporated by reference. According to the invention disclosed in U.S. Pat. No. 6,289,125, the presence of a specific pattern in an input image is detected by detecting predetermined marks from the input image, detecting the locations of the detected marks, and comparing the location relationship of the detected marks with the location relationship of a pre-defined specific pattern.

However, since all objects included in an input image must be compared to detect a mark of the specific pattern, an increased processing time is required, and thereby reproduction productivity is dramatically reduced.

Accordingly, there is a need for an improved method and apparatus for detecting a mark of a specific pattern in an input image without increasing processing time and reducing reproduction productivity.

### SUMMARY OF THE INVENTION

An aspect of embodiments of the present invention is to address at least the above problems and/or disadvantages and to provide at least the advantages described below. Accordingly, an aspect of embodiments of the present invention is to provide a specific pattern detection method and apparatus for detecting whether an input image includes a specific pattern included in currency, such as a bill, which may not be copied.

The present invention provides a copying machine for controlling the printing of an input image for detecting whether the input image includes a specific pattern included in a bill which may not be copied, and a control method thereof.

According to an aspect of an exemplary embodiment of the present invention, there is provided a specific pattern detection method comprising extracting objects corresponding to marks of a specific pattern from an input image. The extracted objects are examined to determine whether the objects have the same location relationship as the marks of the specific pattern. The objects are verified to determine whether the objects having the same location relationship are equal to the marks of the specific pattern. The specific pattern is determined as to whether the pattern exists in the input image from a result of the verification.

The extracted objects size may be the same as the marks of the specific pattern.

The extraction may comprise binarizing the input image by using a first threshold as a reference value and outputting a binary map. Objects are detected from the binary map. A location and size of the objects are calculated. In the outputting of the binary map, if the input image is a color image, RGB input signals may be binarized. If all the RGB input signals are high, a high level may be output.

The examination may comprise dividing the input image into a plurality of tiles. Each of the tiles is examined as to whether the tiles have the location relationship from at least one of the marks of the specific pattern to other marks of the specific pattern.

The verification may comprise obtaining an added value for all pixels of each object by comparing each pixel of the object with a corresponding pixel of the mark, and adding a predetermined value, if the pixel values are equal. The object is determined as being equal to the mark, if the added value exceeds a second threshold. In the obtaining of the added value, the predetermined value may be increased for pixels of a specific portion of pixels of the mark.

According to another aspect of an exemplary embodiment of the present invention, there is provided a specific pattern detection apparatus comprising an object extractor which extracts objects corresponding to marks of a specific pattern from an input image. A location examiner examines whether the extracted objects have a same location relationship as the marks of the specific pattern. An object verifier verifies whether the objects having the same location relationship are equal to the marks of the specific pattern. A specific pattern determinator determines whether the specific pattern exists in the input image from the output of the object verifier.

According to another aspect of an exemplary embodiment of the present invention, there is provided a copying machine print control method for controlling the printing of a copying machine according to whether an input image includes a specific pattern. The method comprises extracting objects corresponding to marks of a specific pattern from the input image. The extracted objects are examined to determine whether the objects have the same location relationship as the marks of the specific pattern. The objects having the location relationship are verified as to whether the objects are equal to the marks of a specific pattern. The specific pattern is determined as to whether the pattern exists in the input image from a result of the verification. The input image is prevented from being printed, if the specific pattern exists in the input image.

According to another aspect of an exemplary embodiment of the present invention, there is provided a copying machine for controlling printing according to whether an input image includes a specific pattern. The copying machine comprises an object extractor which extracts objects corresponding to marks of a specific pattern from an input image. A location examiner examines whether the extracted objects have the same location relationship as the marks of the specific pattern. An object verifier verifies whether the objects having the same location relationship are equal to the marks of the specific pattern. A specific pattern detector, comprising a specific pattern determinator, determines whether the specific pattern exists in the input image from an output of the object verifier. A print controller prevents the input image from being printed, if the specific pattern exists in the input image.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram of a copying machine according to an exemplary embodiment of the present invention;

FIG. 2 is a block diagram of a specific pattern detection apparatus according to an exemplary embodiment of the present invention;

FIG. 3 is a flowchart illustrating a specific pattern detection method according to an exemplary embodiment of the present invention;

FIG. 4 is an illustration of a specific pattern printed on a bill;

FIG. 5 is a detailed block diagram of an object extractor illustrated in FIG. 2;

FIG. 6 is a flowchart illustrating the operation of the object extractor;

FIGS. 7A, 7B, and 7C are illustrations of a binary map output by a binarizing unit illustrated in FIG. 5;

FIGS. 8A, 8B, and 8C are illustrations of results obtained by calculating locations and sizes of centroid pixels of objects in the binary maps illustrated in FIGS. 7A, 7B, and 7C;

FIG. 9 is a detailed block diagram of a location examiner illustrated in FIG. 2;

FIG. 10 is a flowchart illustrating the operation of the location examiner;

FIG. 11A illustrates the location relationship of the specific pattern illustrated in FIG. 4, and FIG. 11B illustrates a tile obtained by dividing the input image;

FIG. 12 is a detailed block diagram of an object verifier illustrated in FIG. 2;

FIG. 13 is a flowchart illustrating the operation of the object verifier;

FIG. 14A is an illustration of an object to be verified, and FIG. 14B is an illustration of a mark of the specific pattern, which is represented as a binary image; and

FIG. 15 is a flowchart illustrating a print control method of the copying machine according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 1 is a block diagram of a copying machine 100 according to an exemplary embodiment of the present invention. Referring to FIG. 1, the copying machine 100 includes a specific pattern detection unit 110, print controller 120, and printing device 130.

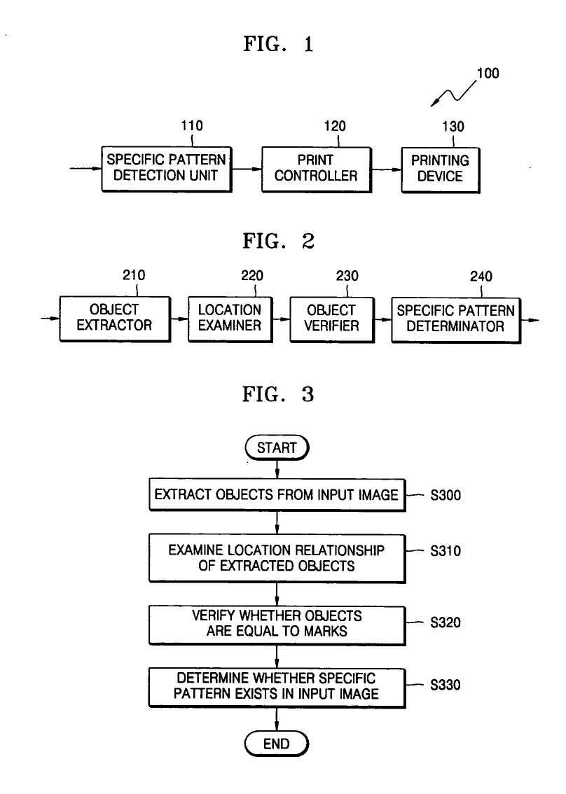

The specific pattern detection unit 110 detects whether an input image includes a specific pattern that is included in a bill, which may not be copied. The input image can be input by a scanning device (not shown) or through an interface (not shown) from an external storage medium. A detailed configuration of the specific pattern detection unit 110 will be described with reference to FIG. 2.

The print controller 120 prevents the input image from being printed, if the specific pattern exists in the input image. The print controller 120 controls the printing device 130 to perform printing.

FIG. 2 is a block diagram of a specific pattern detection unit according to an exemplary embodiment of the present invention. The specific pattern detection unit includes an object extractor 210, location examiner 220, object verifier 230, and specific pattern determinator 240. FIG. 3 is a flowchart illustrating a specific pattern detection method according to an exemplary embodiment of the present invention. An operation of the specific pattern detection apparatus will be described with reference to FIGS. 2 and 3.

In operation S300, the object extractor 210 extracts objects corresponding to marks of the specific pattern from an input image. Here, an object is a mark candidate having a same or similar size to the marks of the specific pattern.

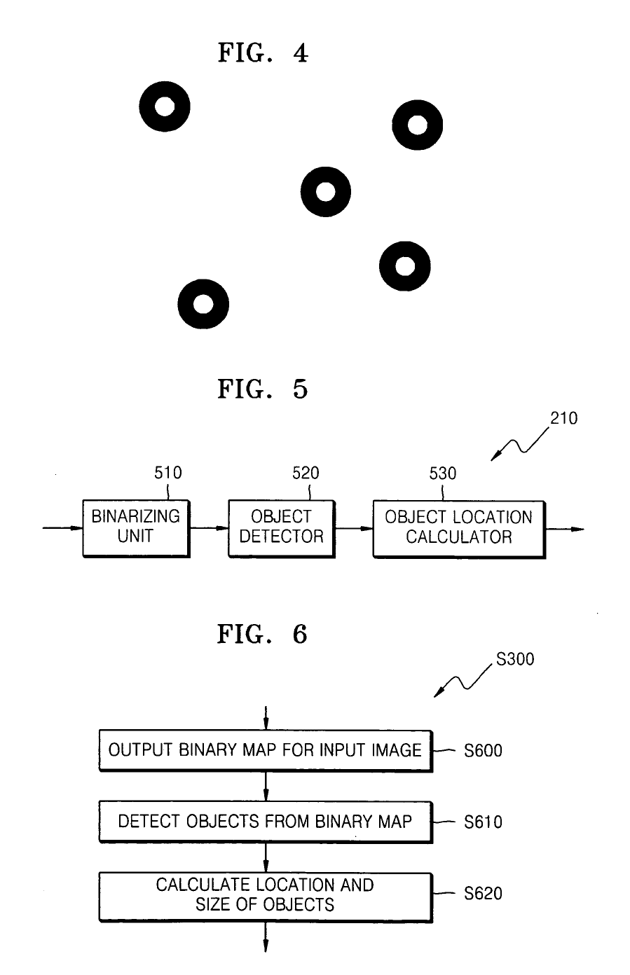

FIG. 4 is an illustration of the specific pattern printed on a bill. Presently, the specific pattern is printed on bank notes, such as 20-dollar bills, Euro currency, and Yen currency. This pattern is called the EURion Constellation. This pattern is a representative example of the pattern to be detected in the following exemplary embodiments of the present invention.

The detailed operation of the object extractor 210 will be described later with reference to FIGS. 5 and 6.

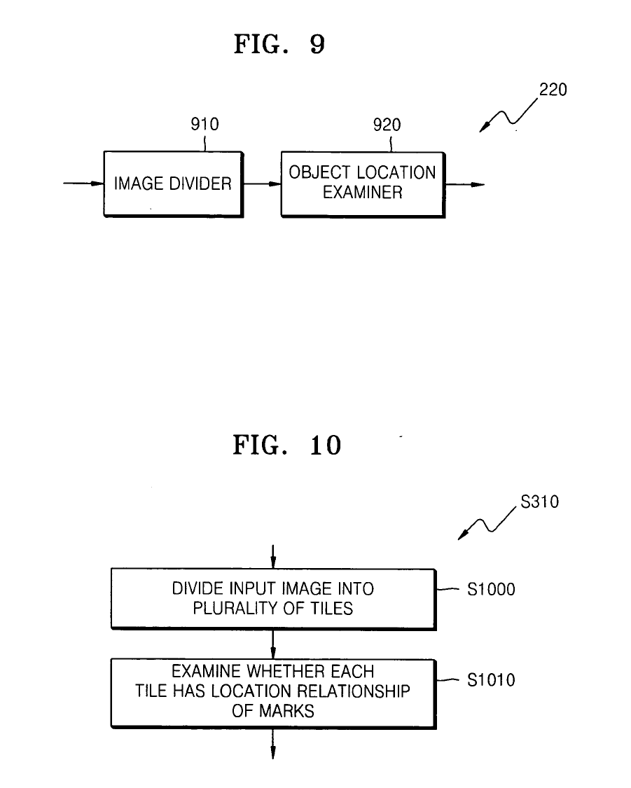

In operation S310, the location examiner 220 examines whether the extracted objects have the same location relationship as the marks of the specific pattern. The detailed operation of the location examiner 220 will be described later with reference to FIGS. 9 and 10.

In operation S320, the object verifier 230 verifies whether the objects having the location relationship are equal to the marks of the specific pattern. The detailed operation of the location examiner 220 will be described later with reference to FIGS. 12 and 13.

In operation S330, the specific pattern determinator 240 determines whether the specific pattern exists in the input image, from the output of the object verifier 230.

FIG. 5 is a detailed block diagram of the object extractor 210 illustrated in FIG. 2. The object extractor 210 includes a binarizing unit 510, object detector 520, and object location calculator 530. FIG. 6 is a flowchart illustrating the operation of the object extractor 210. The operation of the object extractor 210 will be described in association with the components of FIG.5.

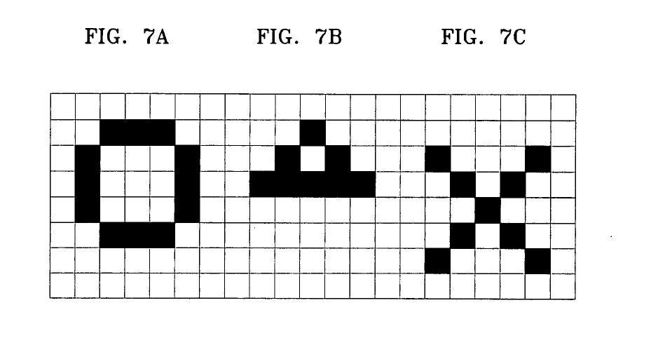

Referring to FIGS. 5 and 6, in operation S600, the binarizing unit 510 binarizes the input image by using a first threshold as a reference value and outputs a binary map. If the input image is a color image, the binarizing unit 510 outputs 1 (high) or 0 (low) by binarizing each of the RGB input signals using the first threshold as the reference value. If all the RGB input signals are high, a high level is output. FIGS. 7A, 7B, and 7C are illustrations of the binary map output by the binarizing unit 510 illustrated in FIG. 5.

In operation S610, the object detector 520 detects objects from the binary map. The object detector 520 connects neighboring pixels using 8-neighbor connectivity for the binary map, and detects objects using a boundary-tracing image processing technique.

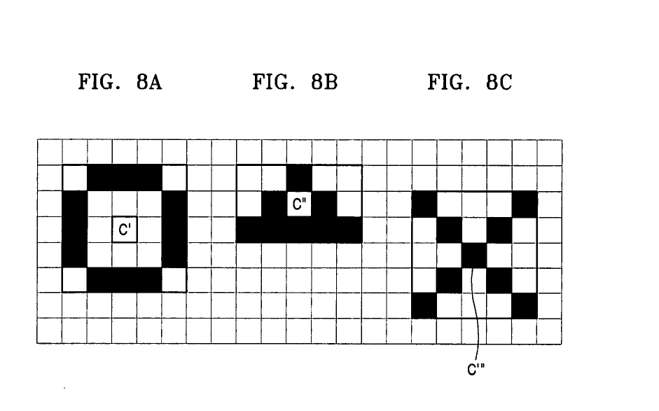

In operation S620, the object location calculator 530 calculates the location and size of each of the objects. FIGS. 8A, 8B, and 8C are illustrations of results obtained by calculating the locations and sizes of centroid pixels of objects in the binary map illustrated in FIGS. 7A, 7B, and 7C. FIG. 8A shows an object whose size is 5×5 and centroid pixel C′ location is (3, 3); FIG. 8B shows an object whose size is 5×3 and centroid pixel C″ location is (9, 2); and FIG. 8C shows an object whose size is 5×5 and centroid pixel C′″ location is (16, 4).

The object location calculator 530 can extract only objects having the same or similar size to the mark of the specific pattern, by comparing the sizes of the calculated objects with the size of the mark of the specific pattern.

FIG. 9 is a detailed block diagram of the location examiner 220 illustrated in FIG. 2. The location examiner 220 includes an image divider 910 and object location examiner 920. FIG. 10 is a flowchart illustrating the operation of the location examiner 220. The operation of the location examiner 220 will be described in association with the components of FIG.9.

Referring to FIGS. 9 and 10, in S1000, the image divider 910 divides the input image into a plurality of tiles. For example, if the size of an input image including the specific pattern is 50×50, then the image is divided into tiles having a size of 100×100, each tile overlapped by a length of 50 on the horizontal axis and the vertical axis.

In operation 1010, the object location examiner 920 examines whether each of the tiles has the location relationship from at least one of the marks of the specific pattern to other marks in the specific pattern.

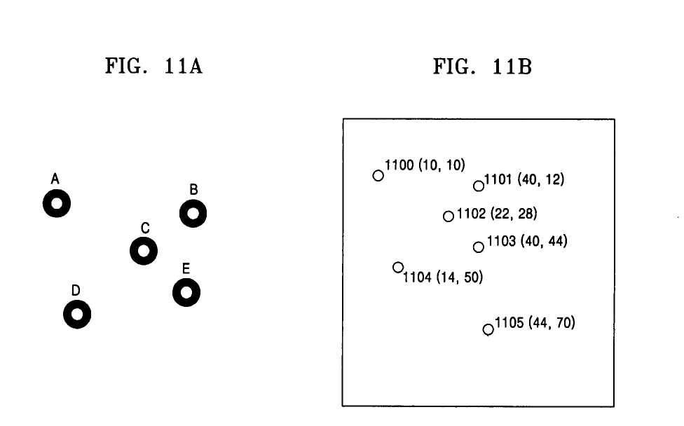

FIG. 11A illustrates the location relationship of the specific pattern illustrated in FIG. 4, and FIG. 11B illustrates a tile obtained by dividing the input image. The tile of FIG. 11B includes 6 objects in an area having a size of 100×100. Each of the objects 1100, 1101, . . . , 1105 has location information of a centroid pixel as illustrated in FIG. 11B.

The examination of the location relationship is achieved by the following process. For one of the plurality of tiles, the validity of the location of a mark C illustrated in FIG. 11A is determined. The validity of the location of the mark C depends on whether all the distance relationships corresponding to segments AC, BC, DC, and EC exist. If the location of the mark C is valid, then the validity of the location of another mark A is determined. If the locations of all the marks are valid, then a determination is made that the object 1100 has the location relationship of the specific pattern. Otherwise, the validity of the locations of all the marks A, B, . . . , E is determined for the other objects 1101, 1102, . . . , 1105 one by one. If the examination of the location relationship for all tiles is finished, then the object location examiner 920 outputs a result to the object verifier 230.

FIG. 12 is a detailed block diagram of the object verifier 230 illustrated in FIG. 2. The object verifier 230 includes a pixel comparator 1210 and an object determinator 1220. FIG. 13 is a flowchart illustrating the operation of the object verifier 230. The operation of the object verifier 230 will be described in association with the components of FIG. 12.

Referring to FIGS. 12 and 13, in operation S1300, the pixel comparator 1210 obtains an added value for all pixels of each object by comparing each pixel of the object with the corresponding pixel of the mark and adding a predetermined value if the pixel values are equal.

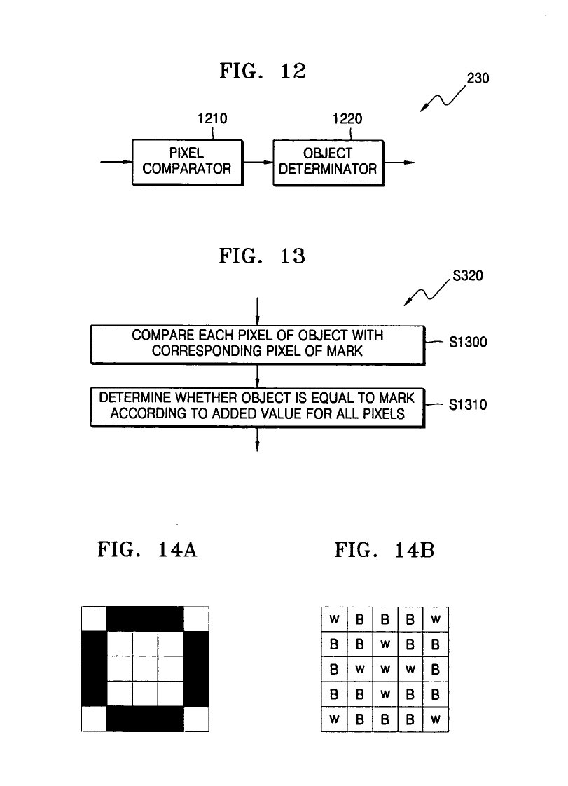

FIG. 14A is an illustration of an object to be verified, and FIG. 14B is an illustration of the mark of the specific pattern, which is represented as a binary image. In FIG. 14B, B denotes black, and W denotes white. The pixel comparator 1210 compares each pixel of the object of FIG. 14A with the corresponding pixel of the mark of FIG. 14B. Since the pixel of the object is white and the pixel of the mark is white, as illustrated in a pixel in the first column and first row in FIG. 14A and 14B, respectively, the predetermined value (for example, 1) is added. On the other hand, if a pixel of the object is black and the corresponding pixel of the mark is white, the predetermined value is not added.

The pixel comparator 1210 can increase the predetermined value for pixels of a specific portion among the pixels of the mark to add the predetermined value, and can subtract the predetermined value if necessary.

In operation S1310, the object determinator 1220 determines that the object is equal to the mark, if the added value exceeds a second threshold.

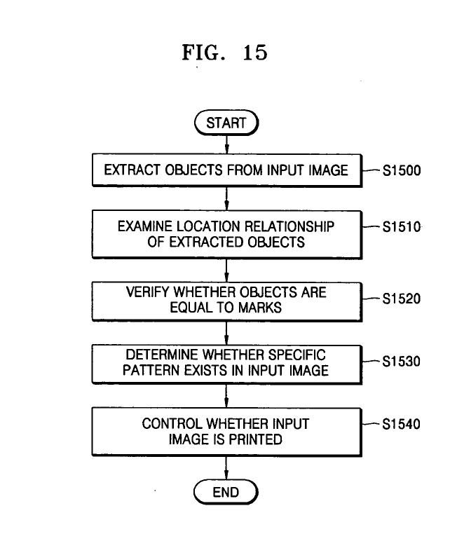

FIG. 15 is a flowchart illustrating a print control method of the copying machine according to an exemplary embodiment of the present invention. The method will be described in association with the components of FIG. 1.

Referring to FIGS. 1 and 15, in operations S1500 through S1530, the specific pattern detection unit 110 detects whether an input image includes the specific pattern included in a bill, which may not be copied. Since operations S1500 through S1530 are equal to operations S300 through S330, detailed descriptions will be omitted for clarity and conciseness.

In operation S1540, the print controller 120 prevents the printing device 130 from printing the input image, if the specific pattern exists in the input image.

As described above, according to exemplary embodiments of the present invention, by extracting objects having the same or similar size to marks of a specific pattern, examining the location relationship of the objects with the marks, comparing the objects with the marks, and verifying the objects, the presence of the specific pattern in an input image can be known instantly. In addition, a copying machine including a specific pattern detection apparatus according to an exemplary embodiment of the present invention can provide convenience to a user by enhancing processing speed, and preventing documents, such as bills, from being illegally copied.

While this invention has been shown and described with reference to certain exemplary embodiments thereof, it will be understood by those skilled in the art that various changes in form and details may be made therein without departing from the spirit and scope of the invention as defined by the appended claims.

What is claimed is:

1. A specific pattern detection method comprising:
extracting objects corresponding to marks of a specific pattern from an input image;
examining whether the extracted objects comprise a same location relationship as the marks of the specific pattern;
verifying whether the objects comprising the same location relationship are equal to the marks of the specific pattern; and
determining whether the specific pattern exists in the input image from a result of the verification.

2. The method of claim 1, wherein the extracted objects size is same as the marks of the specific pattern.

3. The method of claim 1, wherein the extracting comprises:
binarizing the input image by using a first threshold as a reference value and outputting a binary map;
detecting objects from the binary map; and
calculating a location and size of each of the objects.

4. The method of claim 3, wherein in the binarizing, RGB input signals of the input image are binarized, if the input image is a color image, and a high level is output, if all the RGB input signals are high,.

5. The method of claim 1, wherein the examining comprises:
dividing the input image into a plurality of tiles; and
examining whether each of the tiles comprise the location relationship from at least one of the marks of the specific pattern to other marks of the specific pattern.

6. The method of claim 1, wherein the verifying comprises:
obtaining an added value for all pixels of each object, by comparing each pixel of the object with a corresponding pixel of the mark, and adding a value if the pixel values are equal; and
determining that the object is equal to the mark, if the added value exceeds a second threshold.

7. The method of claim 6, wherein in the obtaining of the added value, the value is increased for pixels of a specific portion among pixels of the mark.

8. A specific pattern detection apparatus comprising:
an object extractor for extracting objects corresponding to marks of a specific pattern from an input image;
a location examiner for examining whether the extracted objects comprise a same location relationship as the marks of the specific pattern;
an object verifier for verifying whether the objects comprising the same location relationship are equal to the marks of the specific pattern; and
a specific pattern determinator for determining whether the specific pattern exists in the input image from an output of the object verifier.

9. The apparatus of claim 8, wherein the extracted objects size is same as the marks of the specific pattern.

10. The apparatus of claim 8, wherein the object extractor comprises:
a binarizing unit for binarizing the input image by using a first threshold as a reference value, and outputting a binary map;
an object detector for detecting objects from the binary map; and
an object location calculator for calculating a location and size of each of the objects.

11. The apparatus of claim 10, wherein the binarizing unit binarizes RGB input signals of the input image, if the input image is a color image, and outputs a high level when all the RGB input signals are high.

12. The apparatus of claim 8, wherein the location examiner comprises:
an image divider for dividing the input image into a plurality of tiles; and
an object location examiner for examining whether each of the tiles has the location relationship from at least one of the marks of the specific pattern to other marks of the specific pattern.

13. The apparatus of claim 8, wherein the object verifier comprises:
a pixel comparator for obtaining an added value for all pixels of each object by comparing each pixel of the object with a corresponding pixel of the mark, and adding a value if the pixel values are equal; and
an object determinator for determining that the object is equal to the mark, if the added value exceeds a second threshold.

14. The apparatus of claim 13, wherein the pixel comparator increases the value for pixels of a specific portion among pixels of the mark to add the value.

15. A copying machine print control method for controlling printing of a copying machine according to whether an input image includes a specific pattern, the method comprising:
extracting objects corresponding to marks of a specific pattern from the input image;
examining whether the extracted objects comprise a same location relationship as the marks of the specific pattern;
verifying whether the objects having the same location relationship are equal to the marks of the specific pattern;
determining whether the specific pattern exists in the input image from a result of the verification; and
preventing the input image from being printed, if the specific pattern exists in the input image.

16. The method of claim 15, wherein the extracted objects size is same as the marks of the specific pattern.

17. The method of claim 15, wherein the extracting comprises:
binarizing the input image by using a first threshold as a reference value and outputting a binary map;
detecting objects from the binary map; and
calculating a location and size of each of the objects.

18. The method of claim 17, wherein in the binarizing, RGB input signals of the input image are binarized, if the input image is a color image, and a high level is output, if all the RGB input signals are high.

19. The method of claim 15, wherein the examining comprises:
dividing the input image into a plurality of tiles; and
examining whether each of the tiles comprise the location relationship from at least one of the marks of the specific pattern to other marks of the specific pattern.

20. The method of claim 15, wherein the verification comprises:
obtaining an added value for all pixels of each object by comparing each pixel of the object with a corresponding pixel of the mark, and adding a value if the pixel values are equal; and
determining that the object is equal to the mark, if the added value exceeds a second threshold.

21. The method of claim 20, wherein in the obtaining of the added value, the value is increased for pixels of a specific portion among pixels of the mark.

22. A copying machine for controlling printing according to whether an input image includes a specific pattern, the copying machine comprising:
an object extractor for extracting objects corresponding to marks of a specific pattern from an input image;
a location examiner for examining whether the extracted objects comprise a same location relationship as the marks of the specific pattern;
an object verifier for verifying whether the objects comprising the same location relationship are equal to the marks of the specific pattern;
a specific pattern detector comprising a specific pattern determinator for determining whether the specific pattern exists in the input image from the output of the object verifier; and
a print controller for preventing the input image from being printed, if the specific pattern exists in the input image.

23. The copying machine of claim 22, wherein the extracted objects size is same as the marks of the specific pattern.

24. The copying machine of claim 22, wherein the object extractor comprises:
a binarizing unit for binarizing the input image by using a first threshold as a reference value and outputs a binary map;
an object detector for detecting objects from the binary map; and
an object location calculator for calculating a location and size of each of the objects.

26. The copying machine of claim 24, wherein the binarizing unit binarizes RGB input signals of the input image, if the input image is a color image, and outputs a high level, if all the RGB input signals are high.

27. The copying machine of claim 22, wherein the location examiner comprises:
an image divider for dividing the input image into a plurality of tiles; and
an object location examiner for examining whether each of the tiles comprise the location relationship from at least one of the marks of the specific pattern to other marks of the specific pattern.

28. The copying machine of claim 22, wherein the object verifier comprises:
a pixel comparator for obtaining an added value for all pixels of each object by comparing each pixel of the object with the corresponding pixel of the mark, and adding a value if the pixel values are equal; and
an object determinator for determining that the object is equal to the mark if the added value exceeds a second threshold.

29. The copying machine of claim 27, wherein the pixel comparator increases the value for pixels of a specific portion among pixels of the mark to add the value.
